(19) United States
(12) Patent Application Publication
(10) Pub. No.: US 2018/0254861 A1
(43) Pub. Date: Sep. 6, 2018

(54) AMBIGUOUS CONFIRMATION MESSAGE RESOLUTION

(71) Applicant: QUALCOMM Incorporated, San Diego, CA (US)

(72) Inventors: George CHERIAN, San Diego, CA (US); Alfred ASTERJADHI, San Diego, CA (US); Abhishek Pramod PATIL, San Diego, CA (US)

(21) Appl. No.: 15/910,794

(22) Filed: Mar. 2, 2018

Related U.S. Application Data
(60) Provisional application No. 62/467,077, filed on Mar. 3, 2017.
(60) Provisional application No. 62/528,031, filed on Jun. 30, 2017.
(60) Provisional application No. 62/528,632, filed on Jul. 5, 2017.
(60) Provisional application No. 62/531,552, filed on Jul. 12, 2017.
(60) Provisional application No. 62/531,715, filed on Jul. 12, 2017.

(51) Int. Cl. H04L 1/18

(52) U.S. Cl. CPC H04L 1/1854; H04L 1/1861

(57) ABSTRACT

A method, an apparatus, and a computer-readable medium for wireless communication are provided. In one configuration, the apparatus may be configured to determine when to send an acknowledgment (ACK) frame, a block ACK frame, and/or an all-ACK frame in response to receiving a frame/physical layer convergence procedure (PLCP) protocol data unit (PPDU). In another configuration, the apparatus may be configured to resolve ambiguous confirmation message information. In another configuration, the apparatus may be configured to use an MPDU delimiter to indicate acknowledgement policy.

### CROSS-REFERENCE TO RELATED APPLICATION(S)

This application claims the benefit of U.S. Provisional Application Ser. No. 62/467,077 filed on Mar. 3, 2017, U.S. Provisional Application Ser. No. 62/528,031 filed on Jun. 30, 2017, U.S. Provisional Application Ser. No. 62/528,632 filed on Jul. 5, 2017, U.S. Provisional Application Ser. No. 62/531,552 filed on Jul. 12, 2017, U.S. Provisional Application Ser. No. 62/531,715 filed on Jul. 12, 2017, each of which is hereby incorporated by reference herein in its entirety.

### BACKGROUND

### Field

The present disclosure relates generally to communication systems, and more particularly, to determining when to send an acknowledgment (ACK) frame, a block ACK frame, and/or an all-ACK frame in response to receiving a frame/physical layer convergence procedure (PLCP) protocol data unit (PPDU), resolving ambiguous confirmation message information, and/or using an MPDU delimiter to indicate acknowledgement policy.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, or other frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus (e.g., an access point or a STA) for wireless communication. The apparatus may be configured to receive a frame comprising an aggregated medium access control (MAC) protocol data unit (A-MPDU). The A-MPDU may include at least one MAC protocol data units (MPDU) associated with at least one traffic identifier (TID). The apparatus may be configured to determine whether each of the at least one MPDU associated with the at least one TID is correctly received. The apparatus may be configured to transmit an acknowledgment (ACK) frame, an all-ACK frame, or a block ACK frame for each of the at least one TID based on the determination.

Another aspect of this disclosure provides an apparatus (e.g., an access point or a STA) for wireless communication. The apparatus may be configured to transmit a first frame. The first frame may include a first A-MPDU. The first A-MPDU may include a number of single MPDUs. The number of single MPDUs may be more than one. Each single MPDU of the single MPDUs may be preceded by a respective MPDU delimiter having an end of frame (EOF) field value of 1 and a length field value that is non-zero. The apparatus may be configured to receive a number of first confirmation messages corresponding to one or more of the single MPDUs of the number of single MPDUs. The apparatus may be configured to determine that the number of first confirmation messages is less than the number of single MPDUs. The apparatus may be configured to discard the first confirmation messages based on the determination that the number of confirmation messages is less than the number of single MPDUs.

Another aspect of this disclosure provides an apparatus (e.g., an access point or a STA) for wireless communication. The apparatus may be configured to receive a frame comprising one or more MAC protocol data unit (MPDU) delimiters. Each of the one or more MPDU delimiters may comprise an end of frame (EOF) field having a value indicative of an acknowledgement (ACK) policy.

Another aspect of this disclosure provides an apparatus (e.g., an access point or a STA) for wireless communication. The apparatus may be configured to transmit a frame comprising one or more MAC protocol data unit (MPDU) delimiters. Each of the one or more MPDU delimiters may comprise an end of frame (EOF) field having a value indicative of an acknowledgement (ACK) policy.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows an example wireless communication system in which aspects of the present disclosure may be employed.

FIG. 2 is a diagram of an example frame in accordance with the techniques described herein.

FIG. 3 shows an example functional block diagram of a wireless device configured to perform one or more techniques described herein.

FIG. 4A is a flowchart of a first example of a method of wireless communication in accordance with the techniques described herein.

FIG. 4B is a flowchart of a second example of a method of wireless communication in accordance with the techniques described herein.

FIG. 4C is a flowchart of a third example of a method of wireless communication in accordance with the techniques described herein.

FIG. 4D is a flowchart of a fourth example of a method of wireless communication in accordance with the techniques described herein.

FIG. 5A illustrates an example of a flow diagram between a first device in communication with a second device in accordance with the example method shown in FIG. 4A.

FIG. 5B illustrates an example of a flow diagram between a first device in communication with a second device in accordance with the example method shown in FIG. 4B.

FIG. 5C illustrates an example of a flow diagram between a first device in communication with a second device in accordance with the example methods shown in FIGS. 4C and 4D.

### DETAILED DESCRIPTION

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer-readable media, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects (which may also be described as examples) described herein may apply to any communication standard, such as a wireless protocol.

In some aspects, wireless signals may be transmitted according to an 802.11 protocol using orthogonal frequency-division multiplexing (OFDM), direct—sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, or any other device. In an example, a STA connects to an AP via a Wi-Fi (e.g., IEEE 802.11 protocol) compliant wireless link to obtain general connectivity to the Internet or to other wide area networks. In some implementations, a STA may also be used as an AP. In this regard, a STA may be described as an AP or a non-AP STA. While an AP and a STA are described herein, these are examples of devices that may be configured to perform one or more techniques described herein. For example, reference to an AP may include reference to a first device and reference to a STA may include reference to a second device. As another example, reference to a STA may include reference to a first device and reference to an AP may include reference to a second device.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement a wireless communication standard (also referred to as a wireless standard), such as the 802.11 standard. Such devices, whether used as a STA, an AP, or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g., for use with hotspots), or to implement machine-to-machine communications.

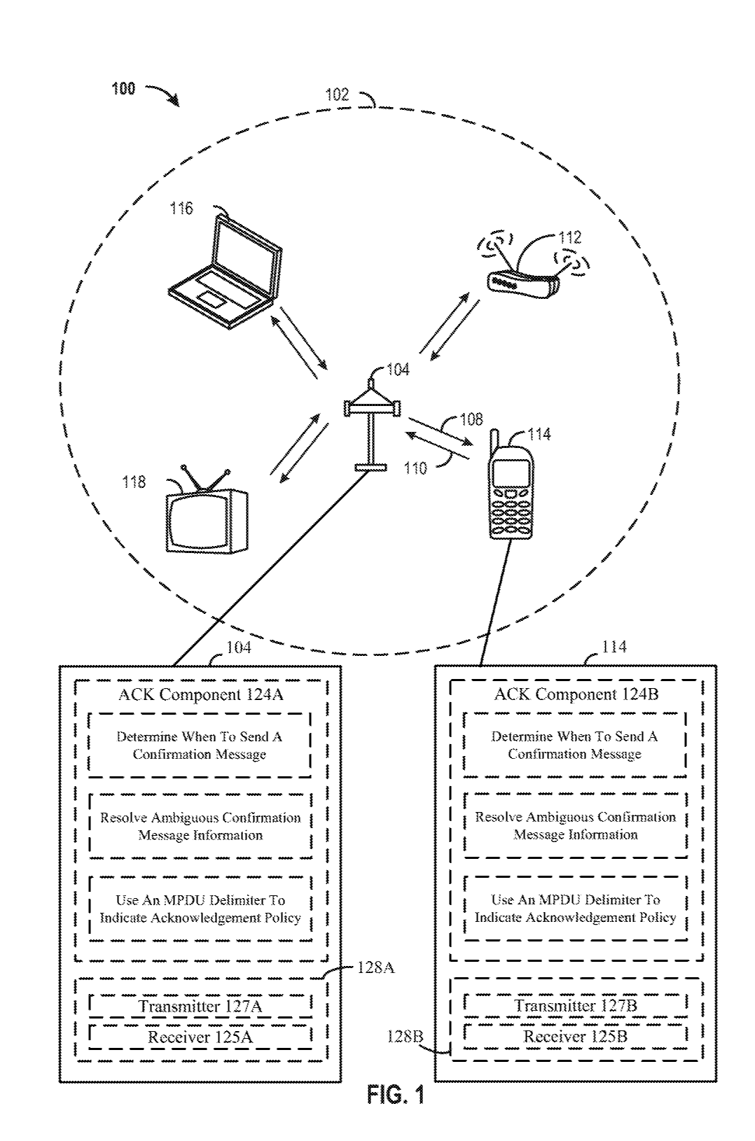

FIG. 1 shows an example wireless communication system 100 in which aspects of the present disclosure may be employed. The wireless communication system 100 may operate pursuant to a wireless standard, such as the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 (or the STA 114 in another aspect) may include one or more components for performing various functions described herein. The AP 104 includes a receiver 125A and a transmitter 127A. The receiver 125A may be configured to perform any receiving function described herein. The transmitter 127A may be configured to perform any transmitting function described herein. The receiver 125A and the transmitter 127A may be combined into a transceiver 128A. In such examples, the transceiver 128A may be configured to perform any receiving function and/or transmitting function described herein with respect to the AP 104.

In some examples, the AP 104 may include an ACK component 124A configured to perform any processing (e.g., functions, steps, or the like) described herein with respect to acknowledgements. Otherwise described, the AP 104 may include an ACK component 124A to perform procedures related to acknowledgments. For example, the ACK component 124A may be configured to determine when to send a confirmation message (e.g., an ACK frame, a block ACK frame, and/or an all-ACK frame), resolve ambiguous confirmation message information, and/or use an MPDU delimiter to indicate acknowledgement policy.

In one configuration, the ACK component 124A may be configured to receive a frame comprising an A-MPDU. The A-MPDU may include at least one MPDU associated with at least one TID. In some examples, one or more MPDUs in an A-MPDU (e.g., each MPDU in an A-MPDU) may be one of the following types: (1) a QoS Data or QoS Null frame, where the TID value (e.g., a value in the range of, for example, 0-15) is indicated in the QoS Control field in the QoS Data or QoS Null frame; or (2) a management frame (e.g., an Action frame) or a control frame (e.g., a PS-Poll frame), where the TID value may not be present in the management frame or the control frame but there may be a default TID value associated with this frame, known on the transmission side (e.g., known at the device that transmits the frame, which may be referred to as the transmitter device) and the reception side (e.g., known at the device that receives the frame, which may be referred to as the receiver device). A receiver device may be any device described herein and a transmitter device may be any device described herein. In some examples, this default TID value may be 15. It is underststood that reference to the TID value being in the range of 0-15 includes 0, 1, 2, 3, 4, 5, 6, 7, 8, 9, 10, 11, 12, 13, 14, or 15.

In some examples, the ACK component 124A may be configured to determine whether each of the at least one MPDU associated with the at least one TID is correctly received. The ACK component 124A may be configured to transmit, depending on what type of ACK frame each MPDU in an A-MPDU solicits, one or more of an ACK frame (e.g., ACK frame 510), an all-ACK frame (e.g., such as that described with respect to ACK frame 520), or a block ACK frame (e.g., such as a multi-STA block ACK frame described with respect to ACK frame 520, multi-TID block ACK frame 610, or a compressed block ACK frame 710) for the received MPDUs for each of the least one TID based on the determination. Otherwise described, an ACK frame (e.g., ACK frame 510) may indicate the receive status of an MPDU (e.g., a single MPDU) in an A-MPDU without identifying the MPDU. In some examples, the ACK frame may not identify the MPDU by virtue of not including the TID value with which the MPDU (i.e., the MPDU that solicited the ACK frame) is associated. An all-ACK frame (e.g., one example implementation of ACK frame 520) may indicate the receive status of all MPDUs in an A-MPDU. In some examples, the all-ACK frame may be a per TID all-ACK frame that acknowledges all MPDUs of an A-MPDU on a per TID basis. In other examples, the all-ACK frame may be an All-TID all-ACK frame that acknowledges all MPDUs of an A-MPDU for all TIDs. A block ACK frame (e.g., such as a multi-STA block ACK frame described with respect to ACK frame 520, multi-TID block ACK frame 610, or a compressed block ACK frame 710) may indicate the receive status of one or more MPDUs in an A-MPDU, where the block ACK frame includes the TID with which each MPDU is associated. For example, the block ACK frame may contain one or more TIDs; and, for each TID, the block ACK frame may include a block ACK bitmap with the receive status of each MPDU of the A-MPDU. It is understood that the phrase “block ACK” may be abbreviated in different ways, such as BA or blockACK.

In another aspect, the STA 114 may include one or more components for performing various functions described herein. The STA 114 includes a receiver 125B and a transmitter 127B. The receiver 125B may be configured to perform any receiving function described herein. The transmitter 127B may be configured to perform any transmitting function described herein. The receiver 125B and the transmitter 127B may be combined into a transceiver 128B. In such examples, the transceiver 128B may be configured to perform any receiving function and/or transmitting function described herein with respect to the STA 114.

In some examples, the STA 114 may include an ACK component 124B configured to perform any processing (e.g., functions, steps, or the like) described herein with respect to acknowledgements. Otherwise described, the STA 114 may include an ACK component 124B to perform procedures related to acknowledgments. For example, the ACK component 124B may be configured to determine when to send a confirmation message (e.g., an ACK frame, a block ACK frame, and/or an all-ACK frame), resolve ambiguous confirmation message information, and/or use an MPDU delimiter to indicate acknowledgement policy.

In one configuration, the ACK component 124B may be configured to receive a frame comprising an A-MPDU. The A-MPDU may include at least one MPDU associated with at least one TID. In some examples, one or more MPDUs in an A-MPDU (e.g., each MPDU in an A-MPDU) may be one of the following types: (1) a QoS Data or QoS Null frame, where the TID value (e.g., a value in the range of, for example, 0-15) is indicated in the QoS Control field in the QoS Data or QoS Null frame; or (2) a management frame (e.g., an Action frame) or a control frame (e.g., a PS-Poll frame), where the TID value may not be present in the management frame or the control frame but there may be a default TID value associated with this frame, known on the transmission side (e.g., known at the device that transmits the frame, which may be referred to as the transmitter device) and the reception side (e.g., known at the device that receives the frame, which may be referred to as the receiver device). In some examples, this default TID value may be 15. It is underststood that reference to the TID value being in the range of 0-15 includes 0, 1, 2, 3, 4, 5, 6, 7, 8, 9, 10, 11, 12, 13, 14, or 15.

In some examples, the ACK component 124B may be configured to determine whether each of the at least one MPDU associated with the at least one TID is correctly received. The ACK component 124B may be configured to transmit, depending on what type of ACK frame each MPDU in an A-MPDU solicits, one or more of an ACK frame (e.g., ACK frame 510), an all-ACK frame (e.g., such as that described with respect to ACK frame 520), or a block ACK frame (e.g., such as a multi-STA block ACK frame described with respect to ACK frame 520, multi-TID block ACK frame 610, or a compressed block ACK frame 710) for the received MPDUs of at least one TID based on the determination. Otherwise described, an ACK frame (e.g., ACK frame 510) may indicate the receive status of an MPDU (e.g., a single MPDU) in an A-MPDU without identifying the MPDU. In some examples, the ACK frame may not identify the MPDU by virtue of not including the TID value with which the MPDU (i.e., the MPDU that solicited the ACK frame) is associated. An all-ACK frame (e.g., one example implementation of ACK frame 520) may indicate the receive status of all MPDUs in an A-MPDU. In some examples, the all-ACK frame may be a per TID all-ACK frame that acknowledges all MPDUs of an A-MPDU on a per TID basis. In other examples, the all-ACK frame may be an All-TID all-ACK frame that acknowledges all MPDUs of an A-MPDU for all TIDs. A block ACK frame (e.g., such as a multi-STA block ACK frame described with respect to ACK frame 520, multi-TID block ACK frame 610, or a compressed block ACK frame 710) may indicate the receive status of one or more MPDUs in an A-MPDU, where the block ACK frame includes the TID with which each MPDU is associated. For example, the block ACK frame may contain one or more TIDs; and, for each TID, the block ACK frame may include a block ACK bitmap with the receive status of each MPDU of the A-MPDU.

As described above, the AP 104 and the STA 114 may include similar components. Therefore, reference to any component without the “A” or the “B” following the reference number refers to the component of either the AP 104 or the STA 114. For example, reference to the ACK component 124 of a first device refers to the ACK component 124A in an example where the first device is the AP 104, or the ACK component 124B in an example where the first device is the STA 114.

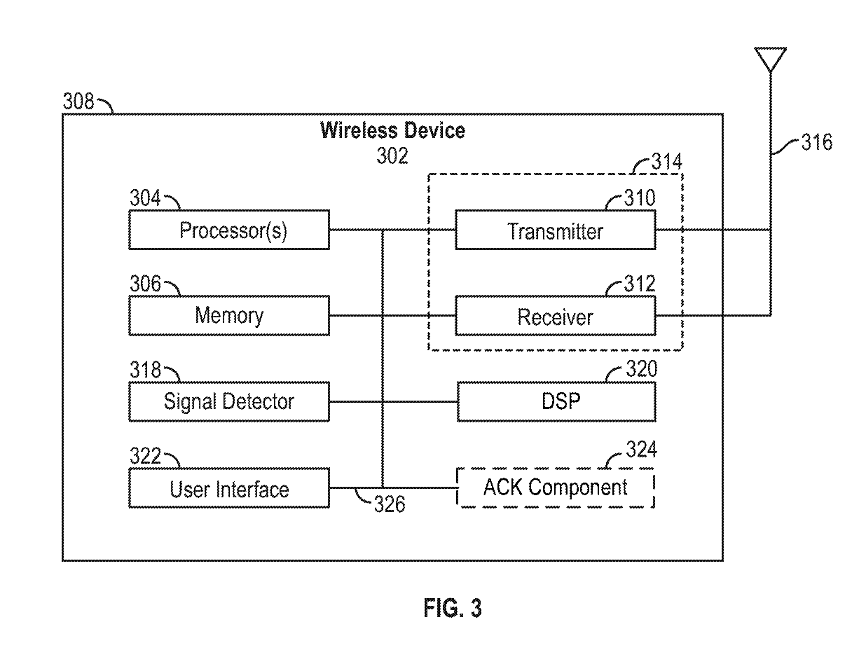

In some examples, a first device (e.g., AP 104, STA 114, wireless device 302, wireless communication device 550, or any other device configured to perform one or more techniques described herein) may include one or more components for performing various functions described herein. Similarly, a second device may be a device (e.g., AP 104, STA 114, wireless device 302, wireless communication device 550, or any other device configured to perform one or more techniques described herein) different than the first device. In examples where the first device is a device depicted in FIG. 1 (e.g., an AP such as the AP 104 or a STA such as the STA 114), it is understood that first device is described with respect to FIG. 1. For example, in an example where the first device is the AP 104, the second device may be the STA 114. As another example, in an example where the first device is the STA 114, the second device may be the AP 104. In examples where the first device is the device in FIG. 3, it is understood that the first device is described with respect to FIG. 3. While the first device is described below generally with reference to components in FIG. 1, it is understood that the first device may be a device depicted in one or more other figures of this disclosure.

For example, the first device may include the ACK component 124, a receiver 125, and a transmitter 127. In an example where the first device is the AP 104, then the ACK component 124 is the ACK component 124A, the receiver 125 is the receiver 125A, and the transmitter 127 is the transmitter 127A. In an example where the first device is the STA 114, then the ACK component 124 is the ACK component 124B, the receiver 125 is the receiver 125B, and the transmitter 127 is the transmitter 127B. The ACK component 124 may be configured to perform procedures related to acknowledgements, such as processing acknowledgements. The receiver 125 and the transmitter 127 may be combined into a transceiver 128. The transmitter 127 may be configured to transmit a first frame to, for example, one or more devices (including, for example, a second device). In some examples, the one or more devices may be one or more APs and/or one or more non-AP STAs.

The first frame may include a first A-MPDU. The first A-MPDU may include a number of single MPDUs. In some examples, the number of single MPDUs is more than one, meaning that the first A-MPDU includes a plurality of single MPDUs. As used herein, the term “single MPDU” may, in some examples, refer to an MPDU that is preceded by an MPDU delimiter having an end of frame (EOF) field value (which may also be referred to as an EOF indicator) of 1 and a length field value that is non-zero. For example, each single MPDU of the single MPDUs may be preceded by a respective MPDU delimiter having an end of frame (EOF) field value of 1 and a length field value that is non-zero. In such an example, a first single MPDU would be preceded by a first MPDU delimiter having an EOF field value of 1 and a length field value that is non-zero, a second single MPDU would be preceded by a second MPDU delimiter having an EOF field value of 1 and a length field value that is non-zero, and a third single MPDU would be preceded by a third MPDU delimiter having an EOF field value of 1 and a length field value that is non-zero. In this example, the second MPDU delimiter may be positioned between the first and second single MPDUs. Similarly, the third MPDU delimiter may be positioned between the second and third single MPDUs. In some examples, MPDUs (e.g., single MPDUs) may be preceded by other MPDU delimiters with an EOF field value of 0 and a length field value not equal to 1 (e.g., when they precede non-single MPDUs) or equal to 0 (e.g., for padding). In some examples, an A-MPDU may be terminated by one or more other MPDU delimiters whose EOF field is 1 and length field equal to 0 for padding as well.

As described herein, it is understood that an A-MPDU may include a plurality of single MPDUs. Since a single MPDU, as defined herein with respect to some examples, refers to an MPDU that is preceded by an MPDU delimiter having an end of frame (EOF) field value of 1, this means that for any particular TID, the A-MPDU may only include one single MPDU for that particular TID. For example, an A-MPDU that includes a plurality of single MPDUs may not include two single MPDUs associated with the same TID.

In some examples, the plurality of single MPDUs may include at least one single MPDU associated with a first TID and at least one single MPDU associated with a second TID, where the second TID is different from the first TID. For example, the plurality of single MPDUs may include a first single MPDU associated with a first TID and a second single MPDU associated with a second TID that is different from the first TID. Otherwise described, the plurality of single MPDUs may be associated with two or more TIDs, where each respective single MPDU is only associated with one TID. For example, referring to the example of a first single MPDU associated with the first TID and the second single MPDU associated with the second TID, this could also be described as the plurality of single MPDUs being associated with a first TID and a second TID. The TID values, in some examples, may range from 0 to 7 (i.e., 0, 1, 2, 3, 4, 5, 6, or 7) for QoS Data or QoS Null frames and the TID value may be 15 if the single MPDU is an Action frame or a PS-Poll frame as described above (or, more generally, a management frame or a control frame, respectively).

The receiver 125 of the first device may be configured to receive a number of first confirmation messages corresponding to one or more of the single MPDUs of the number of single MPDUs. In some examples, the number of received first confirmation messages may be one. In other examples, the number of received first confirmation messages may be more than one. As used herein, a data confirmation message (or, more simply, a confirmation message) may be an ACK frame (e.g., a non-block ACK frame or a block ACK frame). A non-block ACK frame (i.e., an ACK frame that is not a block ACK frame) may not include a traffic identifier (TID) field. A TID field may include a value (e.g., a traffic identifier) indicative of which of the single MPDUs in a soliciting A-MPDU is successfully received. A soliciting A-MPDU may refer to an A-MPDU that includes one or more MPDUs that solicits one or more confirmation messages.

The ACK component 124 of the first device may be configured to determine that the number of first confirmation messages is less than the number of single MPDUs. The ACK component 124 of the first device may be configured to discard the first confirmation messages based on the determination that the number of first confirmation messages is less than the number of single MPDUs. As used herein, the term “discard” and similar terms may, in some examples, refer to non-use. For example, the ACK component 124 of the first device being configured to discard the first confirmation messages may, in some examples, refer to the ACK component 124 of the first device being configured to not use the first confirmation messages. As disclosed below, instead of using the first confirmation messages, the ACK component 124 of the first device may be configured to cause the transmitter 127 to transmit a second frame that includes all of the single MPDUs transmitted in the first A-MPDU of the first frame. This discardment/re-transmission process may, in some examples, continue until the first device receives first confirmation messages for all single MPDUs in an A-MPDU, or otherwise until there is no confirmation message ambiguity.

The discardment of all of the received first confirmation messages corresponding to the single MPDUs resolves the confirmation message ambiguity that arises when a confirmation message is not received for each single MPDU in an A-MPDU when the A-MPDU includes more than one single MPDU. In some examples, the ACK component 124 of the first device may be configured to cause the transmitter 127 to transmit a second frame that includes all of the single MPDUs transmitted in the first A-MPDU of the first frame. In some examples, the second frame may include an A-MPDU (which may be referred to as a second A-MPDU to prevent confusion with the first A-MPDU referenced above). The second A-MPDU may include all of the single MPDUs all of the single MPDUs transmitted in the first A-MPDU of the first frame. All of the single MPDUs in the second A-MPDU of the second frame may be only the single MPDUs associated with each respective first confirmation message that was discarded. In other examples, the second A-MPDU may include single MPDUs in addition to those that are being re-transmitted. Transmitting the second frame constitutes a re-transmission of all of the single MPDUs transmitted in the first A-MPDU of the first frame.

As one example, the number of transmitted single MPDUs in an A-MPDU may be more than one single MPDU. In such an example, the receiver 125 of the first device may be configured to receive, as first confirmation messages, a respective ACK frame (e.g., ACK frame 510) that does not include TID information for less than all of the of the single MPDUs in the A-MPDU. It is understood that reference to an ACK frame not including TID information may be redundant because an ACK frame, as described herein, does not include TID information. However, it is nonetheless stated to serve as a reminder of the significance of the first confirmation messages, in this particular example, being ACK frames. For example, an A-MPDU may include four single MPDUs. In such an example, the first single MPDU may be associated with a first TID among a plurality of TIDs, the second single MPDU may be associated with a second TID among a plurality of TIDs, the third single MPDU may be associated with a third TID among a plurality of TIDs, and the fourth single MPDU may be associated with a fourth TID among a plurality of TIDs. In this example, the first device may receive three or less ACK frames that do not include TID information. As a result of not receiving an ACK frame for each of the single MPDUs (e.g., the first, second, third, and fourth single MPDUs) of the A-MPDU, the ACK component 124 of the first device will be unable to determine which of the one or more single MPDUs was not successfully received since the received ACK frames do not include TID information (i.e., since each of the received ACK frames do not identify the TID value associated with the single MPDU that respectively solicited the ACK frame). For example, where a confirmation message (e.g., an ACK frame) is not received for the third single MPDU, but a respective confirmation message (e.g., an ACK frame) is received for the first, second, and fourth single MPDUs, the ACK component 124 would still be unable to determine that a confirmation was not received for the third single MPDU. This problem can be characterized as a confirmation message ambiguity. To resolve this ambiguity, the ACK component 124 of the first device may be configured to discard the first confirmation messages (e.g., the ACK frames) associated with single MPDUs based on the determination that that the number of confirmation messages (e.g., ACK frames) is less than the number of single MPDUs in the A-MPDU. In some examples, the ACK component 124 of the first device may be configured to cause the transmitter 127 to transmit a second frame that includes one or more of the single MPDUs transmitted in the first A-MPDU of the first frame. In some examples, the second frame may include an A-MPDU (which may be referred to as a second A-MPDU to prevent confusion with the first A-MPDU referenced above). The second A-MPDU may include one or more of all of the single MPDUs transmitted in the first A-MPDU of the first frame. All of the single MPDUs in the second A-MPDU of the second frame may be only the single MPDUs associated with each respective first confirmation message that was discarded. In other examples, the second A-MPDU may include single MPDUs in addition to those that are being re-transmitted or other MPDUs currently queued to be transmitted to the same receiver. Transmitting the second frame constitutes a re-transmission of all of the single MPDUs transmitted in the first A-MPDU of the first frame.

In some examples, the transmitter 127 of the first device may be configured to transmit the second frame that includes all of the single MPDUs transmitted in the first A-MPDU of the first frame. In some examples, the transmitter 127 of the first device may be configured to transmit the second frame after at least one of: the ACK component 124 of the first device determines that the number of first confirmation messages is less than the number of single MPDUs, or the ACK component 124 of the first device discards the first confirmation messages based on the determination that the number of confirmation messages is less than the number of single MPDUs.

In some examples, the first A-MPDU may also include one or more non-single MPDUs. As used herein, the term “non-single MPDU” may, in some examples, refer to an MPDU that is preceded by an MPDU delimiter having an end of frame (EOF) field value (which may also be referred to as an EOF indicator) of 0 and a length field value that is non-zero. For example, each non-single MPDU of the one or more non-single MPDUs may be preceded by a respective MPDU delimiter having an end of frame (EOF) field value of 0 and a length field value that is non-zero. In such an example, a first non-single MPDU would be preceded by a first MPDU delimiter having an EOF field value of 0 and a length field value that is non-zero, a second non-single MPDU would be preceded by a second MPDU delimiter having an EOF field value of 0 and a length field value that is non-zero, and a third non-single MPDU would be preceded by a third MPDU delimiter having an EOF field value of 0 and a length field value that is non-zero. In this example, the second MPDU delimiter may be positioned between the first and second single MPDUs. Similarly, the third MPDU delimiter may be positioned between the second and third single MPDUs.

The receiver 125 of the first device may be configured to receive a second confirmation message. In some examples, the second confirmation message may be a block ACK frame. In some examples, the second confirmation message may include a block ACK (BA) information field that includes BA information. The BA information may include a receive status for each non-single MPDU and/or single MPDU in the first A-MPDU. For example, if an A-MPDU includes 3single MPDUs (each being associated with a different TID value) and 5 non-single MPDUs (2 non-single MPDUs being associated with a first TID value that may or may not overlap with one of the three TID values corresponding to the 3 single MPDUs, and 3 non-single MPDUs being associated with a second TID value that is different from the first TID value and may or may not overlap with one of the three TID values corresponding to the 3 single MPDUs), the BA information may include a first block ACK (e.g., in the form of a TID value, a starting sequence number, and a blockAck bitmap) for the 2 non-single MPDUs associated with the first TID value, and a second block ACK (e.g., in the form of a TID value, a starting sequence number, and a blockAck bitmap) for the 3 non-single MPDUs associated with the second TID value.

In some examples, a block ACK frame may include a compressed block ACK frame, a multi-STA block ACK frame, or multi-TID BlockAck frame. In some examples, the compressed BA frame may be intended for (e.g., transmitted to) one device (e.g., an AP or non-AP STA), and may be configured to acknowledge the receive status of MPDUs associated with one TID (e.g., the compressed BA includes one BA Information field with one TID value and one BA Bitmap). In some examples, the multi-STA BA frame may be intended for (e.g., transmitted to) one or more STAs (e.g., an AP or non-AP STA), and may be configured to acknowledge, for each STA, the receive status of MPDUs from one or more TIDs (and, for each of the TIDs and STAs, the receive status may be indicated as an acknowledgement (e.g., only TID value) or as an block ACK (e.g., TID value, sequence number, and bitmap).

In some examples, the ACK component 124 of the first device may be configured to determine that all of the one or more non-single MPDUs and/or single MPDUs transmitted in the first A-MPDU of the first frame were received by the one or more devices. The ACK component 124 of the first device may be configured to not cause the transmitter 127 to transmit (e.g., re-transmit) any of the one or more non-single MPDUs transmitted in the first A-MPDU of the first frame of the single MPDUs transmitted in the first A-MPDU of the first frame. Similarly, the transmitter 127 of the first device may be configured to not transmit (e.g., re-transmit) any of the one or more non-single MPDUs transmitted in the first A-MPDU of the first frame of the single MPDUs transmitted in the first A-MPDU of the first frame. Otherwise described, the transmitter 127 of the first device may be configured to refrain from transmitting (e.g., re-transmitting) any of the one or more non-single MPDUs transmitted in the first A-MPDU of the first frame of the single MPDUs transmitted in the first A-MPDU of the first frame.

In some examples, the ACK component 124 of the first device may be configured to determine that at least one of the one or more non-single MPDUs transmitted in the first A-MPDU of the first frame was not received. The ACK component 124 of the first device may be configured to not discard the second confirmation message in such examples. Otherwise described, the ACK component 124 of the first device may be configured to refrain from discarding the second confirmation message in such examples.

In some examples, the first device may be configured to transmit a second frame. The second frame may include the at least one of the one or more non-single MPDUs transmitted in the first A-MPDU of the first frame determined not to have been received. In some examples, the second frame does not comprise the at least one of the one or more non-single MPDUs transmitted in the first A-MPDU of the first frame determined to have been received. In some examples, transmission of the second frame constitutes a re-transmission of the at least one of the one or more non-single MPDUs transmitted in the first A-MPDU of the first frame determined not to have been received. The first device may be configured to determine that at least one of the one or more non-single MPDUs transmitted in the first A-MPDU of the first frame was received.

In a wireless communication system, a transmitted frame may be acknowledged by a receiver device upon reception. The frame may include one or more data units (e.g., MPDUs). In an aspect, an ACK frame may be sent by the receiver device of the frame for each successfully received MPDU within the frame. In some instances, when the frame includes multiple MPDUs (e.g., as an A-MPDU), an excessive amount of overhead may be created when a separate ACK frame is sent for each MPDU. To be more efficient, a single block ACK frame may be transmitted, and the block ACK may use a bitmap, for example, in which each bit in the bitmap indicates which MPDUs were successfully received and which MPDUs were not successfully received. In another aspect, all of the MPDUs in the transmitted frame may be successfully received. In this aspect, all of the values in the bitmap of the block ACK, for example, would be identical. To increase efficiency, instead of transmitting a bitmap containing all of the same bit values, an all-ACK frame may be transmitted that indicates all of the MPDUs were successfully received (or not successfully received). For example, if all MPDUs were successfully received, then a single bit within the all-ACK frame may be used to indicate whether all of the MPDUs were successfully received (e.g., all ACK bit=1 may indicate all MPDUs successfully received). This disclosure provides a mechanism for determining whether all MPDUs in an A-MPDU are received correctly, a mechanism for determining whether all MPDUs for a TID in an A-MPDU are received correctly, and a mechanism for indicating an ACK policy for a frame such as a management frame or a block ACK response frame.

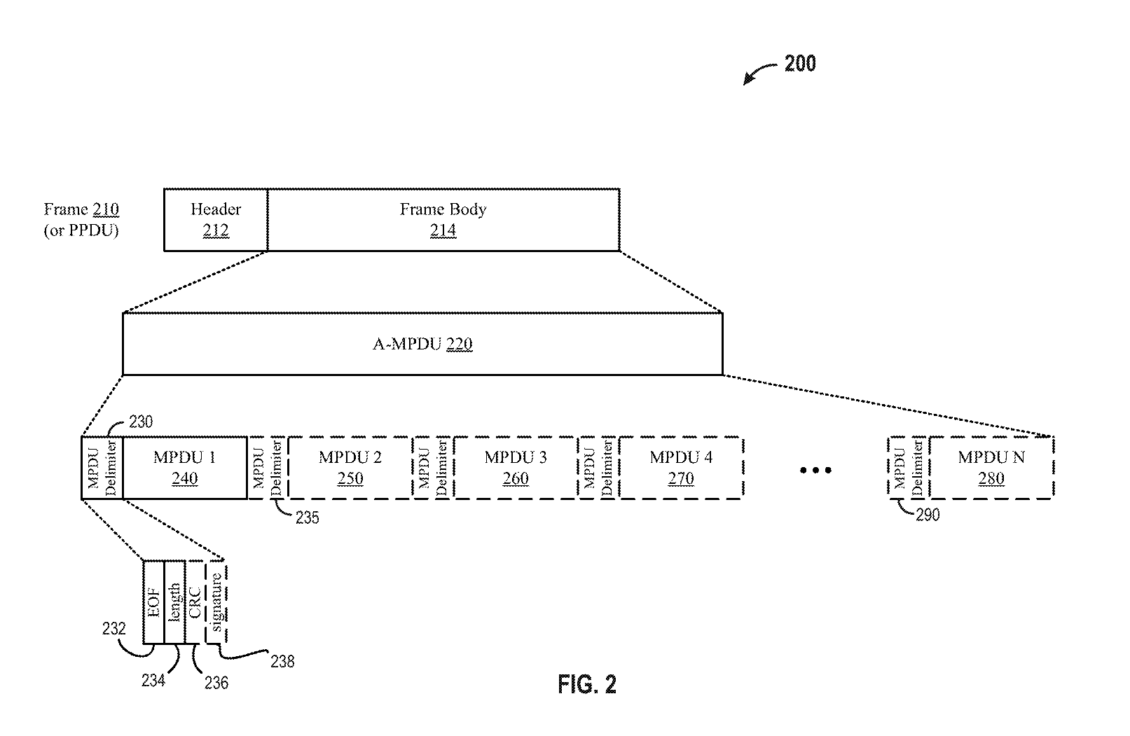

FIG. 2 is a diagram 200 of a frame 210. The frame 210 may be an example of any frame described herein. The frame 210 may include a header 212 and a frame body 214. The header 212 may include a number of fields such as a frame control field, a duration field, a first address field, a second address field, a third address field, a quality of service (QoS) control field, and/or other fields. The frame control field may include control information for the frame 210 such as an indication of a frame type. The duration field may indicate a length of the frame 210 or of a remaining portion of the frame 210 starting from the end of the duration field to the end of the frame body 214. The first address field may indicate a receiver address (RA) or destination address of the frame 210, the second address field may indicate a transmitter address (TA) or a source address, the third address field may indicate a BSSID from which the frame 210 was transmitted. The QoS control field may identify the traffic class (TC) or traffic stream (TS) to which the frame 210 belongs, which in turn, indicates the QoS requirements of the frame 210. TC refers to the type of traffic such as audio or video. TS refers to an instance of a flow or stream of data that originates at a first device and terminates at a second device.

Referring to FIG. 2, the frame body 214 may include user data. The frame body 214 may include an A-MPDU 220, which may contain one or more MPDUs. For example, the A-MPDU 220 may include an MPDU1 240, an MPDU2 250, an MPDU3 260, an MPDU4 270, and/or an MPDUN 280, where N is an integer greater than 1. Each MPDU may be separated by an MPDU delimiter 230, which enables a receiver to parse through each MPDU. The MPDU delimiter 230 may include an end of frame (EOF) indicator 232 (which may also be described as the value/indicator of the EOF field 232), a length field 234, a cyclic redundancy check (CRC) field 236, and optionally a signature 238. The EOF indicator 232 may indicate whether the MPDU following the MPDU delimiter is the last MPDU in the frame 210. For example, if the EOF indicator 232 corresponding to the MPDU1 240 is set to 0, then the MPDU1 240 is not the last MPDU of the frame 210. Otherwise described, an EOF indicator value of 0 of a particular delimiter represents that an MPDU follows or is positioned after the particular delimiter. As another example, if EOF indicator 232 is set to 1, then the MPDU1 240 is the last MPDU of the frame 210. Otherwise described, an EOF indicator value of 1 of a particular delimiter represents that an MPDU does not follow or is not positioned after the particular delimiter. The length field 234 may indicate the length of the MPDU1 240. The length field 234 may enable the receiver device to parse through and extract the MPDU1 240 following the length field 234. The value of a particular length field may be zero or non-zero. The CRC field 236 may indicate whether the MPDU1 240 or the MPDU delimiter 230 was correctly received. The signature 238 may enable software disaggregation. In an aspect, if the MPDU delimiter 230 is corrupt (e.g. the length field 234 has an out of range value, the signature is invalid, or the CRC is invalid), then the receiver device may determine that the MPDU1 240 was not correctly received.

In one configuration, all of the MPDUs in the A-MPDU 220 may be associated with the same TID (e.g., TID 0). The TID may identify the TC and/or TS to which the MPDU belongs. In an aspect, each MPDU in the A-MPDU 220 may indicate the TID associated with the MPDU. For example, the MPDU1 240 may include a TID associated with the MPDU1 240, and the MPDU2 250 may include a TID associated with the MPDU2 250. In this example, both TIDs may have the same value. In this configuration, assuming MPDU1 240 is a first MPDU in the A-MPDU 220 and MPDUN 280 is the last MPDU in the A-MPDU 220, then each MPDU delimiter starting from the MPDU delimiter preceding the MPDU1 240 until the MPDU delimiter preceding MPDUN-1 (the MPDU immediately before MPDUN) may have an EOF indicator set to 0 and a length field set to a non-zero value corresponding to the length of the corresponding MPDU. For the last MPDU, or MPDUN 280, the corresponding MPDU delimiter may have an EOF indicator set to 1 and a length field having a value of 0.

After receiving the frame 210, the receiver device may determine whether each of the one or more MPDUs in the frame 210 is correctly received. The receiver device may parse the A-MPDU 220 by decoding the MPDU delimiter 230 and extracting the length field 234. If the length field 234 is non-zero, then the receiver device may extract the MPDU1 240 based on the length field 234. And if the EOF indicator 232 is non-zero, then the receiver device may move on and attempt to decode the next MPDU delimiter in order to extract the MPDU2 250. The receiver device may continue parsing the A-MPDU 220 until it reaches an MPDU delimiter 290 that immediately precedes the MPDUN 280. The MPDU delimiter 290 may have an EOF indicator set to 1 and a length field set to 0, indicating that MPDUN 280 is the last MPDU in the A-MPDU 220. In an aspect, the MPDUN 280 (or an MPDU immediately following a delimiter with an EOF indicator set to 1 and a length field set to 0) may be repeated multiple times to pad the A-MPDU 220 to satisfy a predetermined length requirement for the A-MPDU 220.

If all of the MPDUs, from the MPDU1 240 (e.g., at the beginning of the A-MPDU 220) to at least the MPDUN 280 (the last MPDU) were received correctly, then the receiver device may transmit an all-ACK frame (e.g., All ACK bit=1), indicating that all of the MPDUs were received correctly. If some MPDUs were received correctly but other MPDUs were received incorrectly, then the receiver device may transmit a block ACK frame instead of an all-ACK frame, and the block ACK frame may indicate which MPDUs were correctly received and which MPDUs were not correctly received. In some examples, the block ACK may include a block ACK bitmap that may be used to indicate which MPDUs were correctly received and which MPDUs were not correctly received.

In another configuration, the A-MPDU 220 may have MPDUs that are associated with different TIDs. For example, the MPDU1 240 and the MPDU2 250 may be associated with TID 0, and the MPDU3 260 through MPDUN 280 may be associated with TID 1. Each of the MPDUs may include the TID with which the MPDU is associated.

In an aspect, MPDUs associated with the same TIDs may be grouped together within the A-MPDU 220. In other words, there is no mixing of MPDUs from different TIDs. For example, because the MPDU2 250 and the MPDU3 260 are associated with different TIDs, then the MPDU4 270 may not have the same TID as MPDU2 250. In this configuration, a last MPDU for each TID may immediately follow an MPDU delimiter having an EOF indicator set to 0 and a length field set to 0 unless the last MPDU for the TID is also the last MPDU for the frame, in which case the EOF indicator may be set to 1 and the length field may be set to 0.

For example, because the MPDU2 250 is the last MPDU associated with TID 0, but is not the last MPDU of the frame 210, an MPDU delimiter 235 associated with the MPDU2 250 may have an EOF indicator set to 0 and a length field set to 0. In this configuration, after receiving the frame 210, the receiver device may determine whether each of the one or more MPDUs for each TID in the frame 210 is correctly received. The receiver device may parse the A-MPDU 220 by decoding the MPDU delimiter 230 and extracting the length field 234. If the length field 234 is non-zero, then the receiver device may extract the MPDU1 240 based on the length field 234. And if the EOF indicator 232 is non-zero, then the receiver device may decode the MPDU delimiter 235 in order to extract the MPDU2 250. The MPDU delimiter 235 may include an EOF indicator set to 0 and a length field set to 0, which together may indicate that the MPDU2 250 is the last MPDU associated with TID 0.

Based on the EOF indicator and the length field of the MPDU delimiter 235, the receiver device may determine that it has extracted the last MPDU of TID 0. If the MPDU1 240 and the MPDU2 250 were correctly received, then the receiver device may determine that all MPDUs associated with the TID 0 were received correctly and transmit an all-ACK frame indicating that the MPDUs for TID 0 were correctly received. Otherwise, if the MPDU1 240 and/or the MPDU2 250 was incorrectly received, then the receiver device may transmit a block ACK frame to indicate which MPDU was correctly or incorrectly received.

Because the EOF indicator for the MPDU2 250 was not equal to 1, the receiver device may determine that additional MPDUs associated with different TIDs follow the MPDU2 250. The receiver device may continue parsing the A-MPDU 220 until it reaches the MPDU delimiter 290 that immediately precedes the MPDUN 280. The MPDU delimiter 290 may have an EOF indicator set to 1 and a length field set to 0, indicating that MPDUN 280 is the last MPDU for TID 1 and for the frame 210. If all of the MPDUs from the MPDU3 260 to the MPDUN 280 (the last MPDU) were received correctly, then the receiver device may transmit an all-ACK frame (e.g., All ACK bit=1) for TID 1, indicating that all of the MPDUs for TID 1 were received correctly. If some MPDUs were received correctly but other MPDUs were received incorrectly, then the receiver device may transmit a block ACK frame instead of an all-ACK frame.

In an aspect, if a TID is associated with a single MPDU with the frame 210, then the receiver device may transmit an ACK frame indicating whether the single MPDU was correctly received, instead of transmitting an all-ACK frame or a block ACK frame.

In another configuration, the A-MPDU 220 may have MPDUs that are associated with different TIDs. Such an A-MPDU may be referred to as a Multi-TID A-MPDU. For example, the MPDU1 240 and the MPDU2 250 may be associated with TID 0, and the MPDU3 260 through MPDUN 280 may be associated with TID 1. In such an example, A-MPDU 220 may be referred to as Multi-TID A-MPDU 220. Each of the MPDUs may include the TID with which the MPDU is associated. In some examples, two or more of the MPDUs in the A-MPDU 220 transmitted by a transmitter of a first device (e.g., an AP or non-AP STA) to a second device (e.g., another AP or non-AP STA) may be single MPDUs. The second device may be configured to generate and transmit one or more confirmation messages to the first device to indicate acknowledgement of reception of the MPDUs of the A-MPDU 220 that were successfully received by the second device.

In some examples, the second device may generate and transmit a block ACK for the received (and not received) non-single MPDUs of the A-MPDU 220. In such an example, the one or more confirmation messages include the block ACK. In some examples, the block ACK transmitted to the first device (i.e., the device that transmitted the A-MPDU 220 to the second device) may be a compressed block ACK, a multi-TID block ACK, or a multi-STA block ACK depending on the example.

In other examples, the one or more confirmation messages may include a normal or basic ACK frame for each single MPDU of the Multi-TID A-MPDU 220. Otherwise described, the second device may generate and transmit a normal or basic ACK frame (which is often simply referred to an ACK frame) for each received single MPDUs of the A-MPDU 220. However, such examples present a problem because upon receiving a particular normal ACK frame, the first device will be unable to determine with which MPDU and/or TID of the A-MPDU 220 the particular normal ACK frame is associated. This is because a normal ACK frame does not include any MPDU identification information, such as TID information and/or a sequence number. Therefore, in the event that less than all single MPDUs of the A-MPDU are received, the first device will be unable to determine which of the one or more single MPDUs were not received and/or determine which TID the second device is responding to. This problem can be characterized as a confirmation message ambiguity.

As a result, in some examples, when A-MPDU 220 includes MPDUs that are associated with different TIDs, the A-MPDU 220 is limited to carrying or otherwise including only a one single MPDU. As addressed above, one reason for limiting an A-MPDU to only having one single MPDU is due to the confirmation message ambiguity when the receiver device misses (e.g., does not receive) at least one of the single MPDUs in an example where the A-MPDU includes a plurality of single MPDUs. For example, where a first device transmits an A-MPDU including a plurality of single MPDUs to a second device and receives confirmation messages for less than all of the single MPDUs in the A-MPDU, the first device would not be able to differentiate which TID the second device is responding to in some examples (e.g., in examples where the confirmation messages received for single MPDUs do not include TID information). However, limiting an A-MPDU to having only one single MPDU is inadequate and inefficient.

The techniques described herein enable a more efficient resolution of this confirmation message ambiguity problem. Specifically, instead of limiting an A-MPDU to having only one single MPDU, an A-MPDU is allowed to have a plurality of single MPDUs. In some examples, a first device having previously transmitted an A-MPDU with a plurality single MPDUs may be configured to determine that all single MPDUs to be missed (e.g., not received) if the first device does not receive a respective ACK frame for each of the plurality of single MPDUs. Otherwise described, the first device may be configured to discard received ACK frames, and be configured to re-transmit all of the single MPDUs, including even the MPDUs for which the first device received an ACK frame. For example, a first device may be configured to transmit an A-MPDU with M number of single MPDUs. If the number of normal ACK frames received by the first device from the second device is less than M, then the first device may be configured to discard all ACK frames that respectively correspond to one of the M single MPDUs. In some examples, this may result in re-transmission of all M single MPDUs in another A-MPDU in another frame. The gains due to including multiple single MPDUs in an A-MPDU is higher compared to the chances of missing at least one of the single MPDUs where the transmitter of the first device would have to transmit all the single MPDUs again.

FIG. 3 is a functional block diagram of a wireless device 302 that may be employed within the wireless communication system 100 of FIG. 1. The wireless device 302 is an example of a device that may be configured to implement the various techniques described herein. For example, the wireless device 302 may be a STA described herein (e.g., STA 114 or any other STA) or an AP described herein (e.g., AP 104 or any other AP). The wireless device 302 may provide different types of ACK frames within the wireless communication system 100 of FIG. 1, may resolve one or more confirmation ambiguities, may use an MPDU delimiter to indicate acknowledgement policy, and/or implement any other technique described herein.

The wireless device 302 may include a processor 304 which controls operation of the wireless device 302. The processor 304 may also be referred to as a central processing unit (CPU). Memory 306, which may include both read-only memory (ROM) and random access memory (RAM), may provide instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable (by the processor 304, for example) to implement the techniques described herein.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 302 may also include a housing 308, and the wireless device 302 may include a transmitter 310 and/or a receiver 312 to allow transmission and reception of data between the wireless device 302 and a remote device. The transmitter 310 and the receiver 312 may be combined into a transceiver 314. An antenna 316 may be attached to the housing 308 and electrically coupled to the transceiver 314. The wireless device 302 may also include multiple transmitters, multiple receivers, multiple transceivers, and/or multiple antennas.

The wireless device 302 may also include a signal detector 318 that may be used to detect and quantify the level of signals received by the transceiver 314 or the receiver 312. The signal detector 318 may detect such signals as total energy, energy per subcarrier per symbol, power spectral density, and other signals. The wireless device 302 may also include a DSP 320 for use in processing signals. The DSP 320 may be configured to generate a packet for transmission. In some aspects, the packet may comprise a physical layer convergence procedure (PLCP) protocol data unit (PPDU).

The wireless device 302 may further comprise a user interface 322 in some aspects. The user interface 322 may comprise a keypad, a microphone, a speaker, and/or a display. The user interface 322 may include any element or component that conveys information to a user of the wireless device 302 and/or receives input from the user.

When the wireless device 302 is implemented as an AP (e.g., the AP 104) or as a STA (e.g., the STA 114), the wireless device 302 may also comprise an ACK component 324. The ACK component 324 may be configured to perform one or more functions described herein. For example, the ACK component 324 may be configured to perform any function described herein with respect to an AP, STA, or any other device described herein. As an example, the ACK component 324 may be configured to perform the functions described herein with respect to the figures. As another example, the ACK component 324 may be configured to perform the functions described herein with respect to the ACK component 124. The transmitter 310 and the receiver 312 may be configured to perform the functions described herein with respect to any transmission or reception function, respectively.

The various components of the wireless device 302 may be coupled together by a bus system 326. The bus system 326 may include a data bus, for example, as well as a power bus, a control signal bus, and a status signal bus in addition to the data bus. Components of the wireless device 302 may be coupled together or accept or provide inputs to each other using some other mechanism.

Although a number of separate components are illustrated in FIG. 3, one or more of the components may be combined or commonly implemented. For example, the processor 304 may be used to implement not only the functionality described above with respect to the processor 304, but also to implement the functionality described above with respect to the signal detector 318, the DSP 320, the user interface 322, and/or the ACK component 324. Further, each of the components illustrated in FIG. 3 may be implemented using a plurality of separate elements.

In some examples, the transmitter 310, the receiver 312, the processor 304, the ACK component 324, and/or one or more other components illustrated in FIG. 3 may be configured to perform one or more functions discussed herein. In some examples, the transmitter 127 may correspond to the transmitter 310, the receiver 125 may correspond to the receiver 312, and the ACK component 124 may correspond to the ACK component 324 and/or the processor 304. Additionally, the means for performing the various functions described herein may include any structure described herein. For example, with reference to FIG. 3, the means for performing the various functions described herein may include one or more components of the wireless device 302. As an example, the means for performing the various functions described herein may include the receiver 312, the transmitter 310, the processor 304, and/or the ACK component 324.

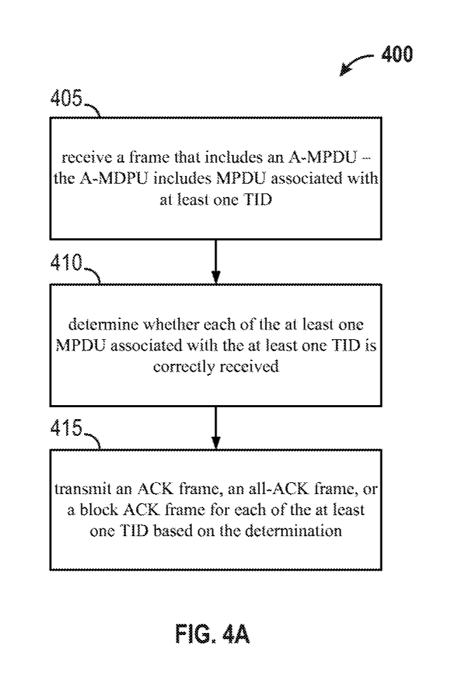

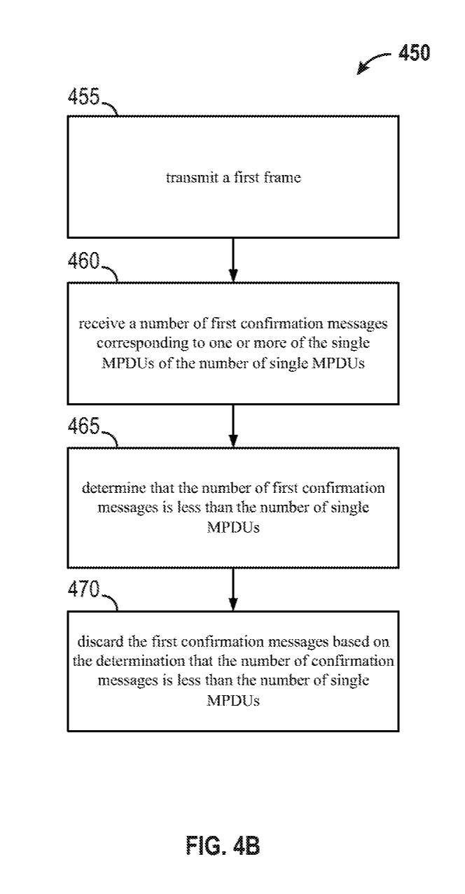

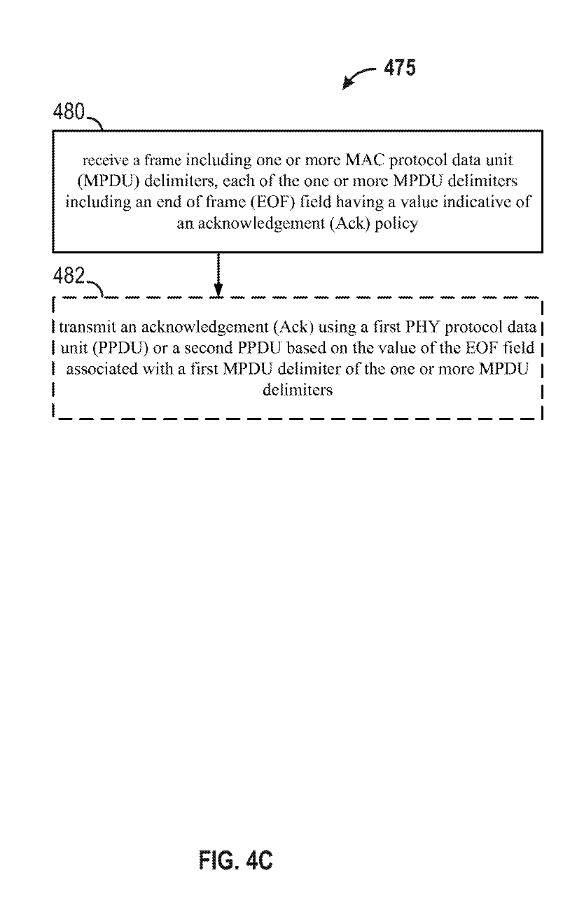

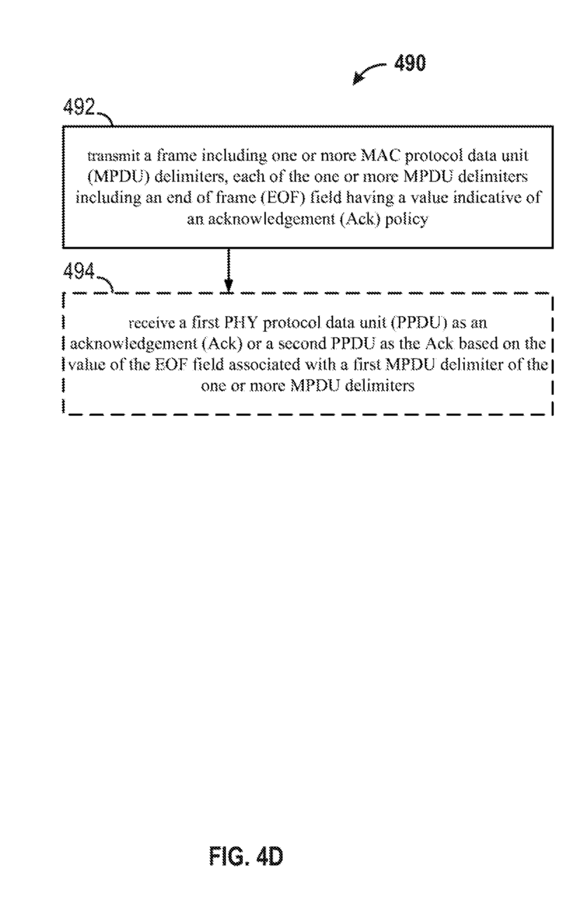

FIG. 4A is a flowchart of an example method of wireless communication in accordance with the techniques described herein. For example, FIG. 4A is a flowchart of an example method 400 of determining when to provide a type of ACK frame. The method 400 may be performed using an apparatus (e.g., the AP 104, the STA 114, the wireless device 302, or any other device configured to perform one or more techniques described herein).

At block 405, the apparatus may receive a frame comprising an A-MPDU. The A-MPDU may include at least one MPDU associated with at least one TID.

At block 410, the apparatus may determine whether each of the at least one MPDU associated with the at least one TID is correctly received.

At block 415, the apparatus may transmit an ACK frame, an all-ACK frame, or a block ACK frame for each of the at least one TID based on the determination.

FIG. 4B is a flowchart of an example method of wireless communication in accordance with the techniques described herein. For example, FIG. 4B is a flowchart of an example method 450 of determining when to discard one or more confirmation messages associated with one or more single MPDUs. The method 450 may be performed using an apparatus (e.g., the AP 104, the STA 114, the wireless device 302, or any other device configured to perform one or more techniques described herein).

At block 455, the apparatus may be configured to transmit a first frame to one or more devices (including, for example, a second device). In some examples, the one or more devices may be one or more APs and/or one or more non-AP STAs. The first frame may include a first A-MPDU. The first A-MPDU may include a number of single MPDUs. In some examples, the number of single MPDUs is more than one, meaning that the first A-MPDU includes a plurality of single MPDUs. In some examples, the plurality of single MPDUs may include at least one single MPDU associated with a first TID and at least one single MPDU associated with a second TID, where the second TID is different from the first TID.

At block 460, the apparatus may be configured to receive a number of first confirmation messages corresponding to one or more of the single MPDUs of the number of single MPDUs. In some examples, the number of received first confirmation messages may be one. In other examples, the number of received first confirmation messages may be more than one.

At block 465, the apparatus may be configured to determine that the number of first confirmation messages is less than the number of single MPDUs. At block 470, the apparatus may be configured to discard the first confirmation messages based on the determination that the number of confirmation messages is less than the number of single MPDUs.

FIG. 4C is a flowchart of an example method of wireless communication in accordance with the techniques described herein. For example, FIG. 4C is a flowchart of an example method 475 of signaling an acknowledgement policy with an MPDU delimiter. The method 475 may be performed using an apparatus (e.g., the AP 104, the STA 114, the wireless device 302, or any other device configured to perform one or more techniques described herein).

At block 480, the apparatus may be configured to receive (e.g., from, for example, a device, such as an AP or non-AP STA) a frame including one or more MAC protocol data unit (MPDU) delimiters. In some examples, each of the one or more MPDU delimiters may include an end of frame (EOF) field having a value indicative of an acknowledgement policy, which may be referred to as an ACK or ACK policy. One example benefit with this technique is that the ACK policy is carried in the MPDU itself. In some examples, each of the one or more MPDU delimiters may include a length field having a non-zero value.

In some examples, the value of the EOF field is indicative that the ACK policy is a first ACK policy when the value is a first value or a second ACK policy when the value is a second value. In some examples, the first value may be 1 and the second value may be 0. In such examples, the first ACK policy may be a normal ACK policy and/or the second ACK policy may be a high efficiency trigger-based PHY protocol data unit (HTP) ACK policy. In other examples, the first value may be 0 and the second value may be 1. In such examples, the first Ack policy may be a normal ACK policy and/or the second ACK policy may be a high efficiency trigger-based PHY protocol data unit (HTP) ACK policy.

At block 482, the apparatus may be configured to transmit (e.g., to a device, such as the device that transmitted the frame to the apparatus) an ACK using a first PHY protocol data unit (PPDU) or a second PPDU based on the value of the EOF field associated with a first MPDU delimiter of the one or more MPDU delimiters. In some examples, the first PPDU may be a single-user (SU) PPDU (which may be referred to as an SU PPDU) and the second PPDU may be a multi-user PPDU. In some examples, the first PPDU may be an SU PPDU and the second PPDU may be a high efficiency (HE) trigger-based (TB) PPDU (which may be referred to as an HE TB PPDU).

In some examples, the apparatus may be configured to transmit the ACK using the first PPDU or the second PPDU after a duration of time. In some examples, the duration of time may be a short interface space (SIFS) duration. In some examples, the value of the EOF field may be a single bit.

In some examples, the frame may include at least one of: one or more MPDU delimiters having an EOF field with a value that is not indicative of an ACK policy; or one or more MPDU delimiters having a length field having a zero value.

In some examples, the frame may include one or more MPDUs, where each of the one or more MPDU delimiters is respectively associated with one of the one or more MPDUs. For example, the one or more MPDU delimiters may include a first MPDU delimiter and a second MPDU delimiter and the one or more MPDUs includes a first MPDU and a second MPDU. In such an example, each of the first and second MPDU delimiters may be respectively associated with one of the one or more MPDUs. For example, the first MPDU delimiter may be associated with the first MPDU and the second MPDU delimiter may be associated with the second MPDU. In some examples, the frame is an aggregated medium access control (MAC) protocol data unit (A-MPDU), wherein the A-MPDU comprises the one or more MPDUs.

FIG. 4D is a flowchart of an example method of wireless communication in accordance with the techniques described herein. For example, FIG. 4D is a flowchart of an example method 490 of signaling an acknowledgement policy with an MPDU delimiter. The method 490 may be performed using an apparatus (e.g., the AP 104, the STA 114, the wireless device 302, or any other device configured to perform one or more techniques described herein).

At block 492, the apparatus may be configured to transmit (e.g., to, for example, a device, such as an AP or non-AP STA) a frame comprising one or more MAC protocol data unit (MPDU) delimiters. In some examples, each of the one or more MPDU delimiters may include an end of frame (EOF) field having a value indicative of an acknowledgement policy. In some examples, each of the one or more MPDU delimiters may include a length field having a non-zero value.

In some examples, the value of the EOF field is indicative that the ACK policy is a first ACK policy when the value is a first value or a second ACK policy when the value is a second value. In some examples, the first value may be 1 and the second value may be 0. In such examples, the first ACK policy may be a normal ACK policy and/or the second ACK policy may be a high efficiency trigger-based PHY protocol data unit (HTP) ACK policy. In other examples, the first value may be 0 and the second value may be 1. In such examples, the first ACK policy may be a normal ACK policy and/or the second ACK policy may be a high efficiency trigger-based PHY protocol data unit (HTP) ACK policy.

At block 494, the apparatus may be configured to receive (e.g., from a device, such as the from the device to which the frame was transmitted) an ACK using a first PHY protocol data unit (PPDU) as an ACK or a second PPDU as the ACK based on the value of the EOF field associated with a first MPDU delimiter of the one or more MPDU delimiters. In some examples, the first PPDU may be a single-user (SU) PPDU (which may be referred to as an SU PPDU) and the second PPDU may be a multi-user PPDU. In some examples, the first PPDU may be an SU PPDU and the second PPDU may be a high efficiency (HE) trigger-based (TB) PPDU (which may be referred to as an HE TB PPDU).

In some examples, the frame may include at least one of: one or more MPDU delimiters having an EOF field with a value that is not indicative of an ACK policy; or one or more MPDU delimiters having a length field having a zero value.

In some examples, the frame may include one or more MPDUs, where each of the one or more MPDU delimiters is respectively associated with one of the one or more MPDUs. For example, the one or more MPDU delimiters may include a first MPDU delimiter and a second MPDU delimiter and the one or more MPDUs includes a first MPDU and a second MPDU. In such an example, each of the first and second MPDU delimiters may be respectively associated with one of the one or more MPDUs. For example, the first MPDU delimiter may be associated with the first MPDU and the second MPDU delimiter may be associated with the second MPDU. In some examples, the frame is an aggregated medium access control (MAC) protocol data unit (A-MPDU), where the A-MPDU comprises the one or more MPDUs.

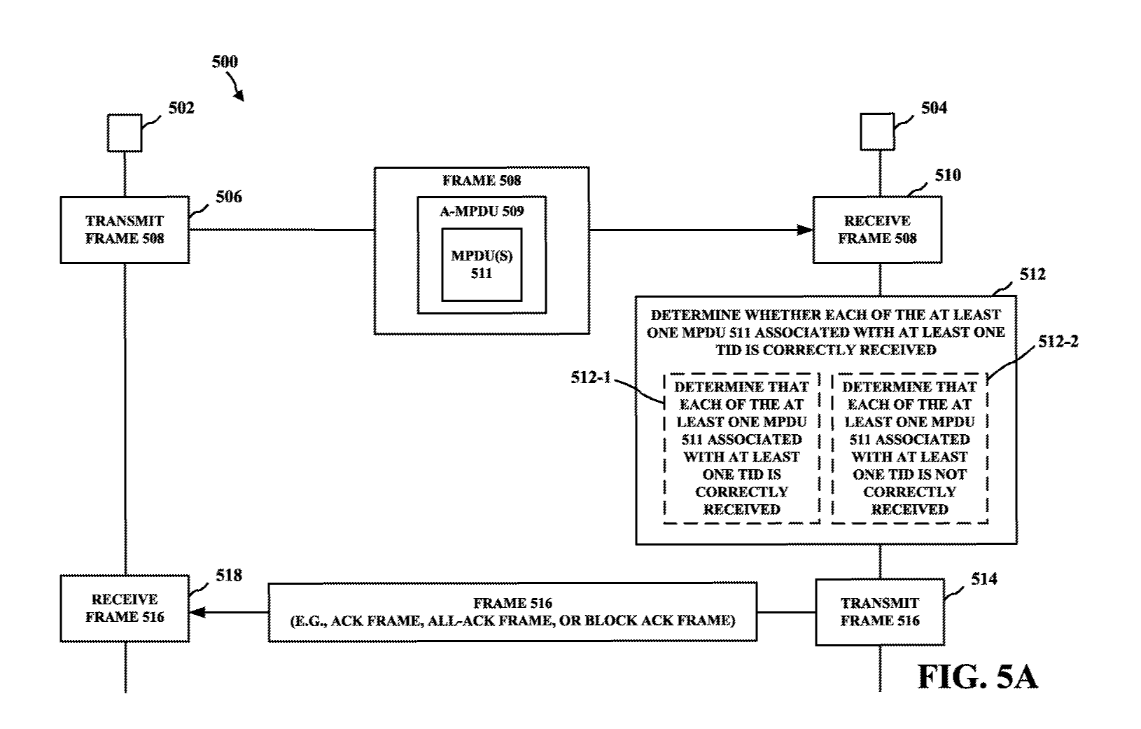

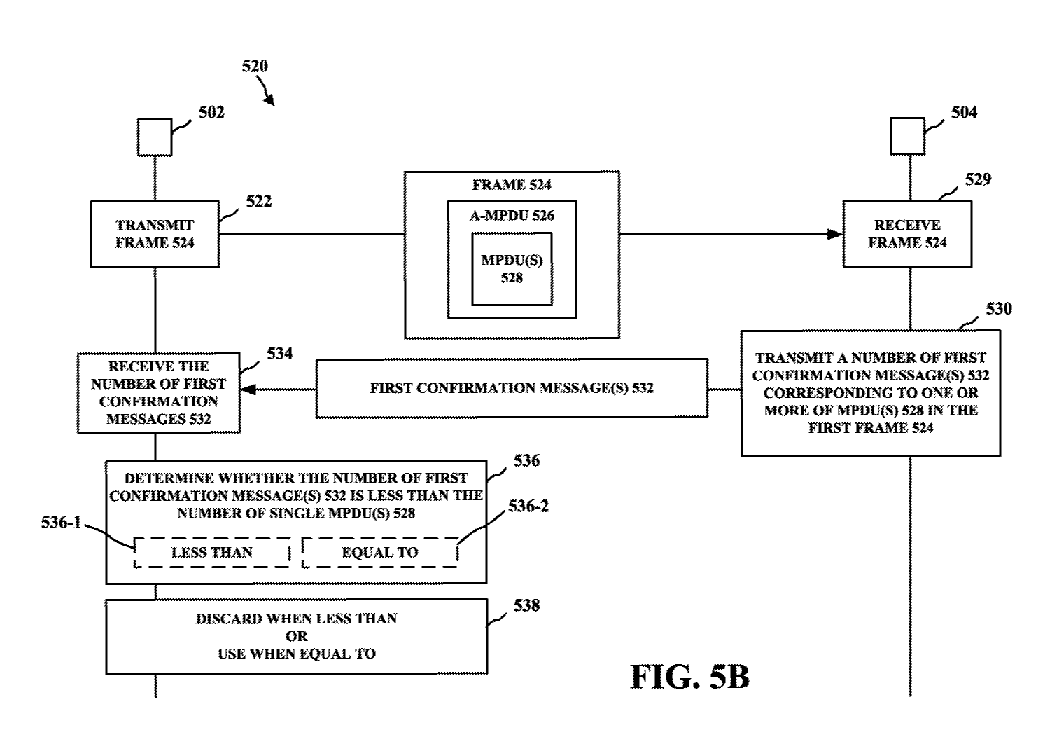

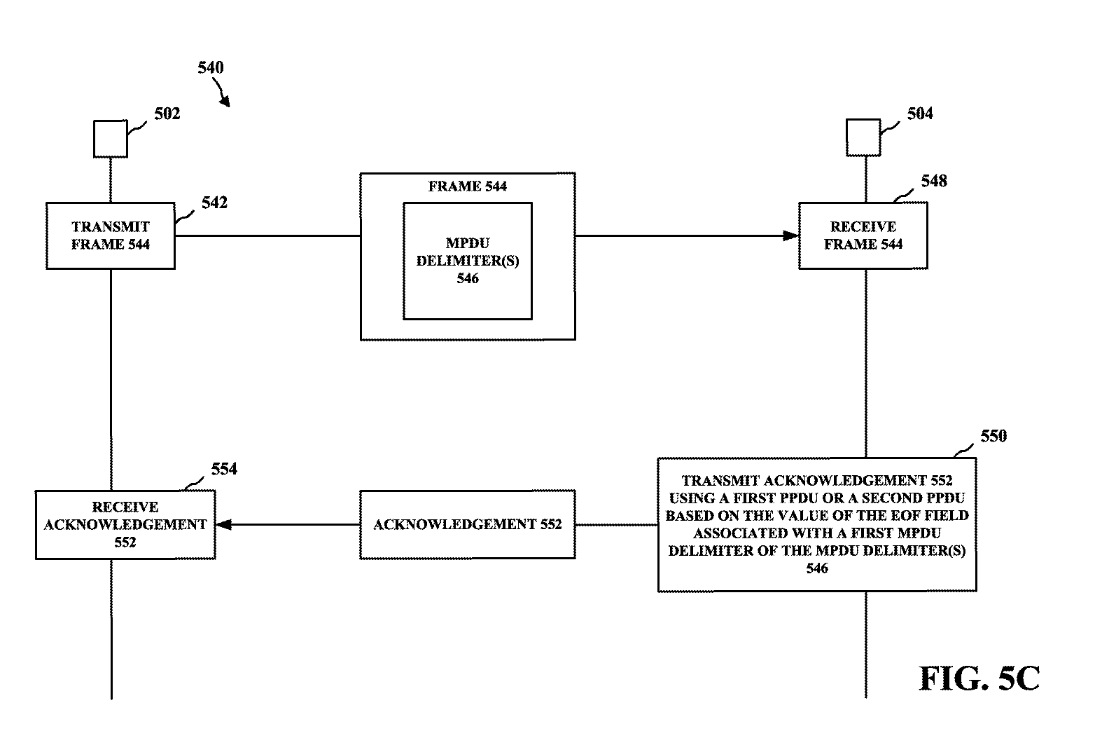

FIG. 5A illustrates an example of a flow diagram 500 between a first device 502 (e.g., any device described herein) in communication with a second device 504 (e.g., any device described herein) in accordance with the example method shown in FIG. 4A. In other examples, one or more techniques described herein may be added to the flow diagram 500 and/or one or more techniques depicted in the flow diagram may be removed.

In the example of FIG. 5A, at block 506, the first device 502 may be configured to transmit a frame 508 that includes an A-MPDU 509 as described herein. For example, the A-MPDU 509 may include at least one MPDU 511 associated with at least one TID. At block 510, the second device 504 may be configured to receive the frame 508. At block 512, the second device 504 may be configured to determine whether each of the at least one MPDU associated with the at least one TID is correctly received. At block 514, the second device 504 may be configured to transmit a frame 516 for each of the at least one TID based on the determination. The frame 516 may be an ACK frame, an all-ACK frame, or a block ACK frame as described herein. For example, at block 512-1, upon determining that each of the at least one MPDU associated with the at least one TID is correctly received, the second device 504 may be configured to transmit, at block 514, the frame 516. However, if at block 512-2 the second device 504 determines that each of the at least one MPDU associated with the at least one TID is not correctly received, then the second device 504 may be configured to not transmit the frame 516 at block 514. In this regard, the transmission that occurs at block 514 is based on the determination at block 512. At block 518, the first device 502 may be configured to receive the frame 516.

FIG. 5B illustrates an example of a flow diagram 520 between a first device 502 (e.g., any device described herein) in communication with a second device 504 (e.g., any device described herein) in accordance with the example method shown in FIG. 4B. In other examples, one or more techniques described herein may be added to the flow diagram 520 and/or one or more techniques depicted in the flow diagram may be removed.

In the example of FIG. 5B, at block 522, the first device 502 may be configured to transmit a first frame 524. The first frame 524 may include a first A-MPDU 526. The first A-MPDU 526 may include a number of single MPDUs 528. In some examples, the number of single MPDUs is more than one, meaning that the first A-MPDU 526 includes a plurality of single MPDUs 528. In some examples, the plurality of single MPDUs 528 may include at least one single MPDU associated with a first TID and at least one single MPDU associated with a second TID, where the second TID is different from the first TID.

At block 529, the second device 504 may be configured to receive the first frame 524. At block 530, in response to the first frame received at block 526, the second device 504 may be configured to transmit a number of first confirmation messages 532 corresponding to one or more of the single MPDUs of the number of single MPDUs in the first frame 524. In some examples, the number of transmitted first confirmation messages 532 may be one. In other examples, the number of transmitted first confirmation messages 532 may be more than one. At block 534, the first device 502 may be configured to receive the number of first confirmation messages 532 corresponding to one or more of the single MPDUs of the number of single MPDUs in the first frame 524. In some examples, the number of received first confirmation messages 532 may be one. In other examples, the number of received first confirmation messages 532 may be more than one.

At block 536, the first device 502 may be configured to determine whether the number of first confirmation messages 532 is less than the number of single MPDUs 528. For example, at block 536-1, the first device 502 may be configured to determine that the number of first confirmation messages 532 is less than the number of single MPDUs 528. Based upon the determination at block 536-1, the first device 502 may be configured to discard the first confirmation messages 532 at block 538. However, at block 536-2, the first device 502 may be configured to determine that the number of first confirmation messages 532 is not less than the number of single MPDUs 528, meaning that the the first device 502 may be configured to determine that the number of first confirmation messages 532 is equal to the number of single MPDUs 528. Based upon the determination at block 536-2, the first device 502 may be configured to not discard the first confirmation messages 532. Otherwise stated, based upon the determination at block 536-2, the first device 502 may be configured to use, at block 538, the first confirmation messages 532 received from the second device 504.

FIG. 5C illustrates an example of a flow diagram 540 between a first device 502 (e.g., any device described herein) in communication with a second device 504 (e.g., any device described herein) in accordance with the example methods shown in FIGS. 4C and 4D. In other examples, one or more techniques described herein may be added to the flow diagram 540 and/or one or more techniques depicted in the flow diagram may be removed.

In the example of FIG. 5C, at block 542, the first device 502 may be configured to transmit a frame 544. The frame 544 may include one or more MAC protocol data unit (MPDU) delimiters 546. In some examples, each of the one or more MPDU delimiters 546 may include an end of frame (EOF) field having a value indicative of an acknowledgement policy. In some examples, each of the one or more MPDU delimiters 546 may include a length field having a non-zero value.

In some examples, the value of the EOF field is indicative that the ACK policy is a first ACK policy when the value is a first value or a second ACK policy when the value is a second value. In some examples, the first value may be 1 and the second value may be 0. In such examples, the first ACK policy may be a normal ACK policy and/or the second ACK policy may be a high efficiency trigger-based PHY protocol data unit (HTP) ACK policy. In other examples, the first value may be 0 and the second value may be 1. In such examples, the first ACK policy may be a normal ACK policy and/or the second ACK policy may be a high efficiency trigger-based PHY protocol data unit (HTP) ACK policy.

At block 548, the second device 504 may be configured to receive the frame 544. At block 550, the second device 504 may be configured to transmit an acknowledgement 552 using a first PPDU or a second PPDU based on the value of the EOF field associated with a first MPDU delimiter of the one or more MPDU delimiters 546. At block 554, the first device 502 may be configured to receive the acknowledgement 552.

In some examples, the first PPDU may be a single-user (SU) PPDU (which may be referred to as an SU PPDU) and the second PPDU may be a multi-user PPDU. In some examples, the first PPDU may be an SU PPDU and the second PPDU may be a high efficiency (HE) trigger-based (TB) PPDU (which may be referred to as an HE TB PPDU).

In some examples, the frame 544 may include at least one of: one or more MPDU delimiters having an EOF field with a value that is not indicative of an ACK policy; or one or more MPDU delimiters having a length field having a zero value.

In some examples, the frame 544 may include one or more MPDUs, where each of the one or more MPDU delimiters 546 is respectively associated with one of the one or more MPDUs. For example, the one or more MPDU delimiters 546 may include a first MPDU delimiter and a second MPDU delimiter and the one or more MPDUs includes a first MPDU and a second MPDU. In such an example, each of the first and second MPDU delimiters may be respectively associated with one of the one or more MPDUs. For example, the first MPDU delimiter may be associated with the first MPDU and the second MPDU delimiter may be associated with the second MPDU. In some examples, the frame 544 is an aggregated medium access control (MAC) protocol data unit (A-MPDU), where the A-MPDU comprises the one or more MPDUs.

Various examples in accordance with the techniques of this disclosure are described herein. Such examples include the examples include the examples described above as well as the examples described below.

### EXAMPLE 1

A method of wireless communication, comprising: receiving a frame comprising an aggregated medium access control (MAC) protocol data unit (A-MPDU), the A-MPDU comprising at least one MAC protocol data units (MPDU) associated with at least one traffic identifier (TID); determining whether each of the at least one MPDU associated with the at least one TID is correctly received; and transmitting an acknowledgment (ACK) frame, an all-ACK frame, or a block ACK frame for each of the at least one TID based on the determination.

### EXAMPLE 2

The method of example 1, wherein the at least one TID comprises a single TID, and wherein the determining comprises: parsing the A-MPDU by extracting each of the at least one MPDU until a last MPDU of the frame associated with an MPDU delimiter comprising an end of frame (EOF) indicator having a value of 1 and a length field having a value of 0 is identified; and attempting to decode each of the extracted at least one MPDU.

### EXAMPLE 3

The method of example 2, wherein the transmitting comprises: transmitting the ACK frame when the A-MPDU comprises a single MPDU; transmitting the all-ACK frame when each MPDU in the at least on MPDU is correctly decoded; or transmitting the block ACK frame when a subset of the at least one MPDUs is correctly decoded.

### EXAMPLE 4

The method of example 1, wherein the at least one TID comprises multiple TIDs, and wherein the determining comprises: performing a first parsing the A-MPDU by extracting a first subset of MPDUs associated with a first TID until a last TID MPDU associated with a first TID MPDU delimiter comprising an end of frame (EOF) indicator having a value of 0 and a length field having a value of 0 is identified; and performing a second parsing the A-MPDU by extracting a second subset of MPDUs associated with a second TID until a last frame MPDU associated with a second TID MPDU delimiter comprising an end of frame (EOF) indicator having a value of 1 and a length field having a value of 0 is identified; and attempting to decode the first and second subsets of MPDUs of the at least one MPDU, wherein the transmission of the ACK frame, the all-ACK frame, or the block ACK frame is based on the attempt to decode.

### EXAMPLE 5

The method of example 4, wherein the first subset of MPDUs associated with the first TID are grouped together in the A-MPDU, and the second subset of MPDUs associated with the second TID are grouped together in the A-MPDU.

### EXAMPLE 6

The method of example 4, wherein the transmitting further comprises: transmitting a first all-ACK frame when all of the MPDUs in the first subset of MPDUs are correctly decoded; and transmitting a second all-ACK frame when all of the MPDUs in the second subset of MPDUs are correctly decoded.

### EXAMPLE 7

An apparatus for wireless communications, comprising: means for performing the various recited functions.

### EXAMPLE 8

An apparatus for wireless communications, comprising: a memory; and at least one processor coupled to the memory and configured to: perform the various recited functions.

### EXAMPLE 9

A computer-readable medium storing computer executable code, comprising code to: perform the various recited functions.

### EXAMPLE 10

A method of wireless communication of a first device, comprising: transmitting a first frame comprising a first aggregated medium access control (MAC) protocol data unit (A-MPDU), the first A-MPDU comprising a number of single MAC protocol data units (MPDUs), wherein the number of single MPDUs is more than one, wherein each single MPDU of the single MPDUs is preceded by a respective MPDU delimiter having an end of frame (EOF) field value of 1 and a length field value that is non-zero; receiving a number of first confirmation messages corresponding to one or more of the single MPDUs of the number of single MPDUs; determining that the number of first confirmation messages is less than the number of single MPDUs; and discarding the first confirmation messages based on the determination that the number of confirmation messages is less than the number of single MPDUs.

### EXAMPLE 11

The method of example 10, wherein the number of first confirmation messages is one, or wherein the number of first confirmation messages is more than one.

### EXAMPLE 12

The method of example 10, wherein at least one of: the number of single MPDUs includes a first single MPDU associated with a first traffic identifier (TID) and a second single MPDU associated with a second TID that is different from the first TID; each first confirmation message does not include a traffic identifier (TID) field; or each first confirmation message is an (ACK) frame.

### EXAMPLE 13

The method of example 10, wherein each first confirmation message is an acknowledgement (ACK) frame, wherein each ACK frame is not a block ACK frame.

### EXAMPLE 14

The method of example 13, wherein a block ACK frame includes a compressed block ACK frame and a multi-STA block ACK frame.

### EXAMPLE 15

The method of example 10, further comprising: transmitting a second frame comprising all of the single MPDUs transmitted in the first A-MPDU of the first frame, wherein transmitting the second frame constitutes a re-transmission of all of the single MPDUs transmitted in the first A-MPDU of the first frame.

### EXAMPLE 16

The method of example 15, wherein the second frame comprises a second A-MPDU comprising all of the single MPDUs transmitted in the first A-MPDU of the first frame.

### EXAMPLE 17

The method of example 10, wherein the first A-MPDU comprises one or more non-single MPDUs, wherein each non-single MPDU of the one or more non-single MPDUs is preceded by a respective MPDU delimiter having an end of frame (EOF) field value of 0 and a length field value that is non-zero.

### EXAMPLE 18

The method of example 17, further comprising: receiving a second confirmation message having one or more ACK blocks.

### EXAMPLE 19

The method of example 18, wherein each ACK block includes an ACK type that differentiates between acknowledgement for each non-single MPDU or single MPDU in the first A-MPDU for a particular TID.

### EXAMPLE 20

The method of example 18, wherein the second confirmation message is a block ACK frame.

### EXAMPLE 21

The method of example 20, wherein a block ACK includes a compressed block ACK frame, a multi-STA block ACK frame, or a multi-TID block ACK frame.

### EXAMPLE 22

The method of example 18, further comprising: determining that all of the one or more non-single MPDUs transmitted in the first A-MPDU of the first frame were received; and refraining from re-transmitting any of the one or more non-single MPDUs transmitted in the first A-MPDU of the first frame.

### EXAMPLE 23

The method of example 18, further comprising: determining that at least one of the one or more non-single MPDUs transmitted in the first A-MPDU of the first frame was not received.

### EXAMPLE 24

The method of example 23, further comprising: refraining from discarding the second confirmation message.

### EXAMPLE 25

The method of example 23, further comprising: transmitting a second frame comprising the at least one of the one or more non-single MPDUs transmitted in the first A-MPDU of the first frame determined not to have been received, wherein transmitting the second frame constitutes a re-transmission of the at least one of the one or more non-single MPDUs transmitted in the first A-MPDU of the first frame determined not to have been received.

### EXAMPLE 26

The method of example 25, further comprising: determining that at least one of the one or more non-single MPDUs transmitted in the first A-MPDU of the first frame was received.

### EXAMPLE 27

The method of example 26, wherein the second frame does not comprise the at least one of the one or more non-single MPDUs transmitted in the first A-MPDU of the first frame determined to have been received.

### EXAMPLE 28

The method of example 10, wherein the first device is an access point (AP) station (STA) or a non-AP STA.

### EXAMPLE 29

The method of example 17, wherein the number of first confirmation messages is one, or wherein the number of first confirmation messages is more than one.

### EXAMPLE 30

The method of example 17, wherein at least one of: each first confirmation message does not include a traffic identifier (TID) field; or each first confirmation message is an (ACK) frame.

### EXAMPLE 31

The method of example 17, wherein each first confirmation message is an acknowledgement (ACK) frame, wherein each ACK frame is not a block ACK frame.

### EXAMPLE 32

The method of example 31, wherein a block ACK frame includes a compressed block ACK frame, a multi-STA block ACK frame, or a multi-TID block ACK frame.

### EXAMPLE 33

The method of example 17, further comprising: transmitting a second frame comprising all of the single MPDUs transmitted in the first A-MPDU of the first frame, wherein transmitting the second frame constitutes a re-transmission of all of the single MPDUs transmitted in the first A-MPDU of the first frame.

### EXAMPLE 34

The method of example 33, wherein the second frame comprises a second A-MPDU comprising all of the single MPDUs transmitted in the first A-MPDU of the first frame.

### EXAMPLE 35

A method of wireless communication, comprising: receiving a frame comprising one or more MAC protocol data unit (MPDU) delimiters, each of the one or more MPDU delimiters comprising an end of frame (EOF) field having a value indicative of an acknowledgement (ACK) policy.

### EXAMPLE 36

The method of example 35, wherein the value of the EOF field is indicative that the ACK policy is a first ACK policy when the value is a first value or a second ACK policy when the value is a second value.

### EXAMPLE 37

The method of example 36, wherein the first value is 1 and the second value 0.

### EXAMPLE 38

The method of example 37, wherein the first ACK policy is a normal ACK policy.

### EXAMPLE 39

The method of example 37, wherein the second ACK policy is a high efficiency trigger-based PHY protocol data unit (HTP) ACK policy.

### EXAMPLE 40

The method of example 36, wherein the first value is 0 and the second value 1.

### EXAMPLE 41

The method of example 40, wherein the first ACK policy is a normal Ack policy.

### EXAMPLE 42

The method of example 40, wherein the second ACK policy is a high efficiency trigger-based PHY protocol data unit (HTP) ACK policy.

### EXAMPLE 43

The method of example 35, wherein each of the one or more MPDU delimiters comprises a length field having a non-zero value.

### EXAMPLE 44

The method of example 35, further comprising: transmitting an acknowledgement (ACK) using a first PHY protocol data unit (PPDU) or a second PPDU based on the value of the EOF field associated with a first MPDU delimiter of the one or more MPDU delimiters.

### EXAMPLE 45

The method of example 44, wherein the first PPDU is a single-user PPDU and the second PPDU is a multi-user PPDU.

### EXAMPLE 46

The method of example 44, wherein the first PPDU is a single-user PPDU and the second PPDU is a high efficiency (HE) trigger-based (TB) PPDU.

### EXAMPLE 47

The method of example 44, further comprising transmitting the ACK using the first PPDU or the second PPDU after a duration of time.

### EXAMPLE 48

The method of example 47, wherein the duration of time is a short interface space (SIFS) duration.

### EXAMPLE 49

The method of example 35, wherein the value of the EOF field is a single bit.

### EXAMPLE 50

The method of example 35, wherein at least one of: the frame comprises one or more MPDU delimiters having an EOF field with a value that is not indicative of an ACK policy; or the frame comprises one or more MPDU delimiters having a length field having a zero value.

### EXAMPLE 51

The method of example 35, wherein the frame includes one or more MPDUs, and wherein each of the one or more MPDU delimiters is respectively associated with one of the one or more MPDUs.

### EXAMPLE 52

The method of example 51, wherein the one or more MPDU delimiters includes a first MPDU delimiter and a second MPDU delimiter and the one or more MPDUs includes a first MPDU and a second MPDU, and wherein each of the first and second MPDU delimiters is respectively associated with one of the one or more MPDUs.

### EXAMPLE 53

The method of example 52, wherein the first MPDU delimiter is associated with the first MPDU and the second MPDU delimiter is associated with the second MPDU.

### EXAMPLE 54

The method of example 51, wherein the frame is an aggregated medium access control (MAC) protocol data unit (A-MPDU), wherein the A-MPDU comprises the one or more MPDUs.

### EXAMPLE 55

A method of wireless communication, comprising: transmitting a frame comprising one or more MAC protocol data unit (MPDU) delimiters, each of the one or more MPDU delimiters comprising an end of frame (EOF) field having a value indicative of an acknowledgement (ACK) policy.

### EXAMPLE 56

The method of example 55, wherein the value of the EOF field is indicative that the ACK policy is a first ACK policy when the value is a first value or a second ACK policy when the value is a second value.

### EXAMPLE 57

The method of example 56, wherein the first value is 1 and the second value 0.

### EXAMPLE 58

The method of example 57, wherein the first ACK policy is a normal ACK policy.

### EXAMPLE 59

The method of example 57, wherein the second ACK policy is a high efficiency trigger-based PHY protocol data unit (HTP) ACK policy.

### EXAMPLE 60

The method of example 56, wherein the first value is 0 and the second value 1.

### EXAMPLE 61

The method of example 60, wherein the first ACK policy is a normal ACK policy.

### EXAMPLE 62

The method of example 60, wherein the second ACK policy is a high efficiency trigger-based PHY protocol data unit (HTP) ACK policy.

### EXAMPLE 63

The method of example 55, wherein each of the one or more MPDU delimiters comprises a length field having a non-zero value.

### EXAMPLE 64

The method of example 55, further comprising: receiving a first PHY protocol data unit (PPDU) as an acknowledgement (ACK) or a second PPDU as the ACK based on the value of the EOF field associated with a first MPDU delimiter of the one or more MPDU delimiters.

### EXAMPLE 65

The method of example 64, wherein the first PPDU is a single-user PPDU and the second PPDU is a multi-user PPDU.

### EXAMPLE 66

The method of example 64, wherein the first PPDU is a single-user PPDU and the second PPDU is a high efficiency (HE) trigger-based (TB) PPDU.

### EXAMPLE 67

The method of example 55, wherein the value of the EOF field is a single bit.

### EXAMPLE 68

The method of example 55, wherein at least one of: the frame comprises one or more MPDU delimiters having an EOF field with a value that is not indicative of an ACK policy; or the frame comprises one or more MPDU delimiters having a length field having a zero value.

### EXAMPLE 69

The method of example 55, wherein the frame includes one or more MPDUs, and wherein each of the one or more MPDU delimiters is respectively associated with one of the one or more MPDUs.

### EXAMPLE 70

The method of example 67, wherein the one or more MPDU delimiters includes a first MPDU delimiter and a second MPDU delimiter and the one or more MPDUs includes a first MPDU and a second MPDU, and wherein each of the first and second MPDU delimiters is respectively associated with one of the one or more MPDUs.

### EXAMPLE 71

The method of example 68, wherein the first MPDU delimiter is associated with the first MPDU and the second MPDU delimiter is associated with the second MPDU.

### EXAMPLE 72

The method of example 67, wherein the frame is an aggregated medium access control (MAC) protocol data unit (A-MPDU), wherein the A-MPDU comprises the one or more MPDUs.

### EXAMPLE 73

A method comprising one or more techniques described in this disclosure.

### EXAMPLE 74

A method comprising any combination of examples 1-73.

### EXAMPLE 75

Any device described in this disclosure.

### EXAMPLE 76

An apparatus for wireless communications, comprising: a memory; and at least one processor coupled to the memory and configured to: perform one or more techniques described in this disclosure.

### EXAMPLE 77

An apparatus for wireless communications, comprising: a memory; and at least one processor coupled to the memory and configured to: perform the method of any of examples 1-74 or any combination of examples 1-74.

### EXAMPLE 78

An apparatus comprising one or more means for performing one or more techniques described in this disclosure.

### EXAMPLE 79

An apparatus comprising one or more means for performing the method of any of examples 1-74 or any combination of examples 1-74.

### EXAMPLE 80

The apparatus of example 78 or 79, wherein the one or more means comprises one or more processors.

### EXAMPLE 81

A computer-readable medium storing computer executable code, comprising code to: perform one or more techniques described in this disclosure.

### EXAMPLE 82

A computer-readable medium storing computer executable code, comprising code to: perform the method of any of examples 1-74 or any combination of examples 1-74.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication of a first device, comprising:
transmitting a first frame comprising a first aggregated medium access control (MAC) protocol data unit (A-MPDU), the first A-MPDU comprising a number of single MAC protocol data units (MPDUs), wherein the number of single MPDUs is more than one, wherein each single MPDU of the single MPDUs is preceded by a respective MPDU delimiter having an end of frame (EOF) field value of 1 and a length field value that is non-zero;
receiving a number of first confirmation messages corresponding to one or more of the single MPDUs of the number of single MPDUs;
determining that the number of first confirmation messages is less than the number of single MPDUs; and
discarding the first confirmation messages based on the determination that the number of confirmation messages is less than the number of single MPDUs.

2. The method of claim 1, wherein the number of single MPDUs includes a first single MPDU associated with a first traffic identifier (TID) and a second single MPDU associated with a second TID that is different from the first TID.

3. The method of claim 1, wherein each first confirmation message of the number of first confirmation messages is an acknowledgement (ACK) frame, wherein each ACK frame is not a block ACK frame.

4. The method of claim 3, wherein a block ACK frame is a compressed block ACK frame or a multi-STA block ACK frame.

5. The method of claim 1, further comprising:
transmitting a second frame comprising all of the single MPDUs transmitted in the first A-MPDU of the first frame, wherein transmitting the second frame constitutes a re-transmission of all of the single MPDUs transmitted in the first A-MPDU of the first frame.

6. The method of claim 5, wherein the second frame comprises a second A-MPDU.

7. The method of claim 1, wherein the first A-MPDU comprises one or more non-single MPDUs, wherein each non-single MPDU of the one or more non-single MPDUs is preceded by a respective MPDU delimiter having an end of frame (EOF) field value of 0 and a length field value that is non-zero.

8. The method of claim 7, further comprising:
receiving a second confirmation message having one or more ACK blocks.

9. The method of claim 8, wherein each ACK block of the one or more ACK blocks includes an ACK type that differentiates between acknowledgement for each non-single MPDU or single MPDU in the first A-MPDU for a particular TID.

10. The method of claim 8, wherein the second confirmation message is a block ACK frame.

11. The method of claim 10, wherein a block ACK frame is a compressed block ACK frame, a multi-STA block ACK frame, or a multi-TID block ACK frame.

12. The method of claim 8, further comprising:
determining that at least one of the one or more non-single MPDUs transmitted in the first A-MPDU of the first frame was not received.

13. The method of claim 12, further comprising:
refraining from discarding the second confirmation message.

14. The method of claim 13, further comprising:
transmitting a second frame comprising the at least one of the one or more non-single MPDUs transmitted in the first A-MPDU of the first frame determined not to have been received, wherein transmitting the second frame constitutes a re-transmission of the at least one of the one or more non-single MPDUs transmitted in the first A-MPDU of the first frame determined not to have been received.

15. The method of claim 14, further comprising:
determining that at least one of the one or more non-single MPDUs transmitted in the first A-MPDU of the first frame was received.

16. The method of claim 15, wherein the second frame does not comprise the at least one of the one or more non-single MPDUs transmitted in the first A-MPDU of the first frame determined to have been received.

17. A first device, comprising:
a memory; and
at least one processor communicatively coupled to the memory, wherein the at least one processor is configured to:
transmit a first frame comprising a first aggregated medium access control (MAC) protocol data unit (A-MPDU), the first A-MPDU comprising a number of single MAC protocol data units (MPDUs), wherein the number of single MPDUs is more than one, wherein each single MPDU of the single MPDUs is preceded by a respective MPDU delimiter having an end of frame (EOF) field value of 1 and a length field value that is non-zero;
receive a number of first confirmation messages corresponding to one or more of the single MPDUs of the number of single MPDUs;
determine that the number of first confirmation messages is less than the number of single MPDUs; and
discard the first confirmation messages based on the determination that the number of confirmation messages is less than the number of single MPDUs.

18. The first device of claim 17, wherein the number of single MPDUs includes a first single MPDU associated with a first traffic identifier (TID) and a second single MPDU associated with a second TID that is different from the first TID.

19. The first device of claim 17, wherein the at least one processor is configured to:
transmit a second frame comprising all of the single MPDUs transmitted in the first A-MPDU of the first frame, wherein transmission of the second frame constitutes a re-transmission of all of the single MPDUs transmitted in the first A-MPDU of the first frame.

20. The first device of claim 17, wherein the first A-MPDU comprises one or more non-single MPDUs, wherein each non-single MPDU of the one or more non-single MPDUs is preceded by a respective MPDU delimiter having an end of frame (EOF) field value of 0 and a length field value that is non-zero.

21. The first device of claim 20, wherein the at least one processor is configured to:
receive a second confirmation message having one or more ACK blocks.

22. The first device of claim 21, wherein the second confirmation message is a block ACK frame.

23. The first device of claim 22, wherein a block ACK frame is a compressed block ACK frame, a multi-STA block ACK frame, or a multi-TID block ACK frame.

24. The first device of claim 21, wherein the at least one processor is configured to:
determine that at least one of the one or more non-single MPDUs transmitted in the first A-MPDU of the first frame was not received.

25. The first device of claim 24, wherein the at least one processor is configured to:
refrain from discarding the second confirmation message.

26. The first device of claim 25, wherein the at least one processor is configured to:
transmit a second frame comprising the at least one of the one or more non-single MPDUs transmitted in the first A-MPDU of the first frame determined not to have been received, wherein transmission of the second frame constitutes a re-transmission of the at least one of the one or more non-single MPDUs transmitted in the first A-MPDU of the first frame determined not to have been received.

27. The first device of claim 26, wherein the at least one processor is configured to:
determine that at least one of the one or more non-single MPDUs transmitted in the first A-MPDU of the first frame was received.

28. The first device of claim 27, wherein the second frame does not comprise the at least one of the one or more non-single MPDUs transmitted in the first A-MPDU of the first frame determined to have been received.

29. An apparatus for wireless communication, comprising:
means for transmitting a first frame comprising a first aggregated medium access control (MAC) protocol data unit (A-MPDU), the first A-MPDU comprising a number of single MAC protocol data units (MPDUs), wherein the number of single MPDUs is more than one, wherein each single MPDU of the single MPDUs is preceded by a respective MPDU delimiter having an end of frame (EOF) field value of 1 and a length field value that is non-zero;
means for receiving a number of first confirmation messages corresponding to one or more of the single MPDUs of the number of single MPDUs;
means for determining that the number of first confirmation messages is less than the number of single MPDUs; and
means for discarding the first confirmation messages based on the determination that the number of confirmation messages is less than the number of single MPDUs.

30. A computer-readable medium having code stored thereon that, when executed, causes at least one processor of a wireless device to:
transmit a first frame comprising a first aggregated medium access control (MAC) protocol data unit (A-MPDU), the first A-MPDU comprising a number of single MAC protocol data units (MPDUs), wherein the number of single MPDUs is more than one, wherein each single MPDU of the single MPDUs is preceded by a respective MPDU delimiter having an end of frame (EOF) field value of 1 and a length field value that is non-zero;
receive a number of first confirmation messages corresponding to one or more of the single MPDUs of the number of single MPDUs;
determine that the number of first confirmation messages is less than the number of single MPDUs; and
discard the first confirmation messages based on the determination that the number of confirmation messages is less than the number of single MPDUs.
